(19) United States
(12) Patent Application Publication
(10) Pub. No.: US 2025/0377036 A1
(43) Pub. Date: Dec. 11, 2025

(54) GEARBOX

(71) Applicant: Whipps, Inc., Athol, MA (US)

(72) Inventor: Richard L. Adams, Athol, MA (US)

(21) Appl. No.: 19/235,166

(22) Filed: Jun. 11, 2025

Related U.S. Application Data
(60) Provisional application No. 63/658,717, filed on Jun. 11, 2024.

(51) Int. Cl. F16H 25/20; E05F 11/40

(52) U.S. Cl. CPC F16H 25/20; E05F 11/40; F16H 2025/2046; F16H 2025/2053; F16H 2025/2093

(57) ABSTRACT

Apparatus for effecting movement of an object, the apparatus comprising: a first bevel gear having a first central opening formed therein, the first bevel gear comprising an upper surface and a lower surface; a second bevel gear having a second central opening formed therein, the second bevel gear comprising an upper surface and a lower surface; a first threaded stem passing through the first central opening of the first bevel gear, the first threaded stem comprising a thread configured to mate with a thread formed in the first central opening of the first bevel gear; a second threaded stem passing through the second central opening of the second bevel gear, the second threaded stem comprising a thread configured to mate with a thread formed in the second central opening of the second bevel gear; a pinion gear comprising a first end and a second end, wherein the first end of the pinion gear is configured to engage a plurality of teeth formed on the upper surface of the first bevel gear, and the second end of the pinion gear is configured to engage a plurality of teeth formed on the lower surface of the second bevel gear; and wherein rotation of the first bevel gear in a first direction effects (i) longitudinal movement of the first threaded stem relative to the first bevel gear, and (ii) rotation of the second bevel gear in the first direction, and further wherein rotation of the second bevel gear in the first direction effects longitudinal movement of the second threaded stem relative to the second bevel gear.

### REFERENCE TO PENDING PRIOR PATENT APPLICATION

This patent application claims benefit of pending prior U.S. Provisional Patent Application Ser. No. 63/658,717, filed Jun. 11, 2024 by Whipps, Inc. and Richard L. Adams for GEARBOX (Attorney's Docket No.: WHIPPS-9 PROV).

The above-identified patent application is hereby incorporated herein by reference.

### FIELD OF THE INVENTION

This invention relates to gearboxes in general, and more particularly to gearboxes utilizing dual stems for effecting movement of objects relative to the gearbox.

### BACKGROUND OF THE INVENTION

Gearboxes are mechanical devices for translating movement of a first object (e.g., rotation of a crank) into movement of a second object (e.g., the lifting of a gate). One or more gears connect the first object to the second object, allowing for the movement force to be spread out relative to the second object and/or to leverage force multiplication through gearing.

By way of example but not limitation, gearboxes are commonly used in order to effect movement of slide gates for controlling fluid flow through a passageway or channel. Looking now at FIG. 1, there is shown an exemplary slide gate 5. Slide gate 5 generally comprises a frame assembly 10 which defines an opening 15 through which fluid flows, a slide plate 20 movably mounted to frame assembly 10 and configured to selectively move relative thereto so as to selectively open and close opening 15 in frame assembly 10, sealing members 25 for providing a substantially watertight seal between slide plate 20 and frame assembly 10, and an operating mechanism 30 for vertically moving slide plate 20 between its open and closed positions so as to regulate fluid flow through opening 15 in frame assembly 10.

Looking now at FIGS. 1-3, operating mechanism 30 generally comprises two stems 35A, 35B mounted to slide plate 20, with stem 35A comprising a thread extending in a first direction (e.g., a right-handed thread) and stem 35B comprising a thread extending in a second, opposite direction (e.g., a left-handed thread). A gearbox 40 is mounted to an upper portion of frame assembly 10 such that stems 35A, 35B pass through gearbox 40 and may be selectively rotated (and hence, moved longitudinally) relative thereto, as will hereinafter be discussed.

More particularly, and looking now at FIGS. 2 and 3, gearbox 40 generally comprises a first bevel gear 45, a second bevel gear 50, and a pinion shaft 55 connecting first bevel gear 45 and second bevel gear 50. Pinion shaft 55 generally comprises a first end 60 having a first pinion gear 65 mounted thereto, and a second end 70 having a second pinion gear 75 mounted thereto. A third pinion gear 80 is provided which interacts with first bevel gear 45 for selectively driving rotation of first bevel gear (i.e., by rotating third pinion gear 80 using a crank or electric motor), whereby to cause rotation of first bevel gear 45, first pinion gear 65, pinion shaft 55, second pinion gear 75 and second bevel gear 50, as will hereinafter be discussed in further detail.

First bevel gear 45 comprises a threaded central opening 85 configured to receive the thread of stem 35A, and a plurality of teeth 90 disposed on the upper surface of first bevel gear 45 for mating with counterpart teeth located on first pinion gear 65 and third pinion gear 80. Second bevel gear 50 comprises a threaded central opening 95 configured to receive the thread of stem 35B, and a plurality of teeth 100 disposed on the upper surface of second bevel gear 50 for mating with counterpart teeth located on second pinion gear 75.

As a result of this construction, and looking now at FIG. 3, with such prior art gearboxes, rotation of third pinion gear 80 (e.g., via a crank, not shown) in a clockwise direction causes (i) first bevel gear 45 to rotate in a clockwise direction, (ii) first pinion gear 65 (and hence pinion shaft 55 and second pinion gear 75) to rotate in a counter-clockwise direction, and (iii) second bevel gear 50 to rotate in a counter-clockwise direction. It will be appreciated that, inasmuch as first bevel gear 45 and second bevel gear 50 are rotating in opposite directions as a result of the foregoing construction, it is necessary to provide stems 35A, 35B with oppositely-directed threads, such that both stems 35A, 35B move in concert longitudinally as first bevel gear 45 and second bevel gear 50 rotate.

While the foregoing gearbox 40 is commonly used in the art, the requirement of stems 35A, 35B having oppositely-directed threads is a significant drawback. Particularly in applications where stems 35A, 35B must be manufactured to be robust enough to move heavy loads and withstand wear, stems 35A, 35B must be carefully machined. Specialized equipment exists for manufacturing robust stems comprising a thread of a particular directionality, however, the fact that prior art gearboxes (e.g., gearbox 40) require oppositely-directed threads on stems 35A, 35B means that the equipment used to manufacture the stems must be modified in order to produce stems having oppositely-directed threads. Given the size and complexity of the machinery used to manufacture such stems, this need for modification greatly increases the cost of producing stems having oppositely-directed threads using the same machine. As a practical matter, it is common to seek stems having oppositely-directed threads from different suppliers (i.e., suppliers using different machines to manufacture stems), because the cost for a single manufacturer to produce stems having oppositely-directed threads is prohibitive.

Thus there is a need for a new and improved gearbox which operates to move at least two stems having threads of the same directionality disposed thereon, such that the stems move longitudinally in a common direction, eliminating the need to provide stems having oppositely-directed threads.

### SUMMARY OF THE INVENTION

The present invention comprises the provision and use of a new and improved gearbox which operates to move at least two stems having threads of the same directionality disposed thereon, such that the stems move longitudinally in a common direction, eliminating the need to provide stems having oppositely-directed threads.

In one preferred form of the invention, there is provided apparatus for effecting movement of an object, the apparatus comprising:
a first bevel gear having a first central opening formed therein, the first bevel gear comprising an upper surface and a lower surface;
a second bevel gear having a second central opening formed therein, the second bevel gear comprising an upper surface and a lower surface; a first threaded stem passing through the first central opening of the first bevel gear, the first threaded stem comprising a thread configured to mate with a thread formed in the first central opening of the first bevel gear;
a second threaded stem passing through the second central opening of the second bevel gear, the second threaded stem comprising a thread configured to mate with a thread formed in the second central opening of the second bevel gear;
a pinion gear comprising a first end and a second end, wherein the first end of the pinion gear is configured to engage a plurality of teeth formed on the upper surface of the first bevel gear, and the second end of the pinion gear is configured to engage a plurality of teeth formed on the lower surface of the second bevel gear; and
wherein rotation of the first bevel gear in a first direction effects (i) longitudinal movement of the first threaded stem relative to the first bevel gear, and (ii) rotation of the second bevel gear in the first direction, and further wherein rotation of the second bevel gear in the first direction effects longitudinal movement of the second threaded stem relative to the second bevel gear.

In another preferred form of the invention, there is provided a method for moving an object, the method comprising:
providing apparatus for effecting movement of the object, the apparatus comprising:
   a first bevel gear having a first central opening formed therein, the first bevel gear comprising an upper surface and a lower surface;
   a second bevel gear having a second central opening formed therein, the second bevel gear comprising an upper surface and a lower surface;
   a first threaded stem passing through the first central opening of the first bevel gear, the first threaded stem comprising a thread configured to mate with a thread formed in the first central opening of the first bevel gear;
   a second threaded stem passing through the second central opening of the second bevel gear, the second threaded stem comprising a thread configured to mate with a thread formed in the second central opening of the second bevel gear; and
   a pinion gear comprising a first end and a second end, wherein the first end of the pinion gear is configured to engage a plurality of teeth formed on the upper surface of the first bevel gear, and the second end of the pinion gear is configured to engage a plurality of teeth formed on the lower surface of the second bevel gear; and
rotating the first bevel gear in a first direction, whereby to effect (i) longitudinal movement of the first threaded stem relative to the first bevel gear, and (ii) rotation of the second bevel gear in the first direction, wherein rotation of the second bevel gear in the first direction effects longitudinal movement of the second threaded stem relative to the second bevel gear, such that the first threaded stem and the second threaded stem move longitudinally in concert with one another.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1-3 are schematic views showing an exemplary prior art gearbox used in combination with a slide gate; and

FIG. 4 is a schematic view of a novel gearbox formed in accordance with the present invention.

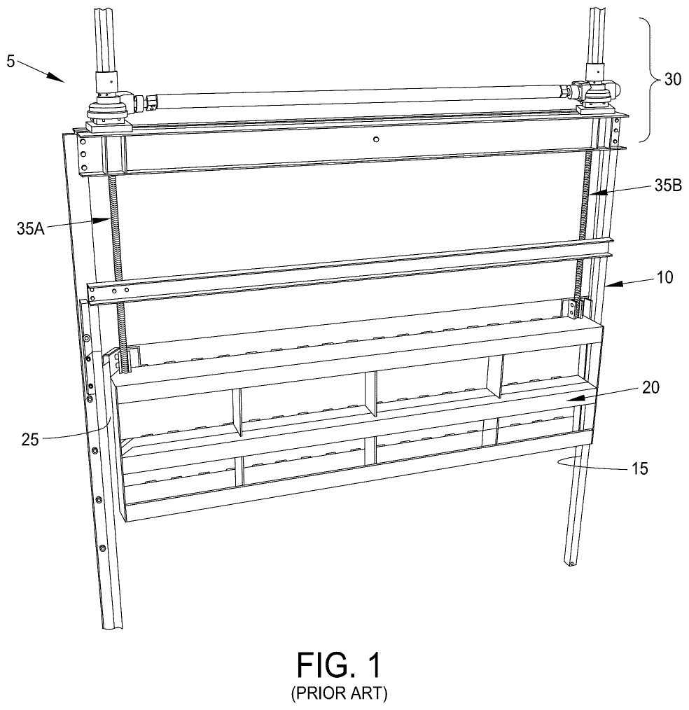

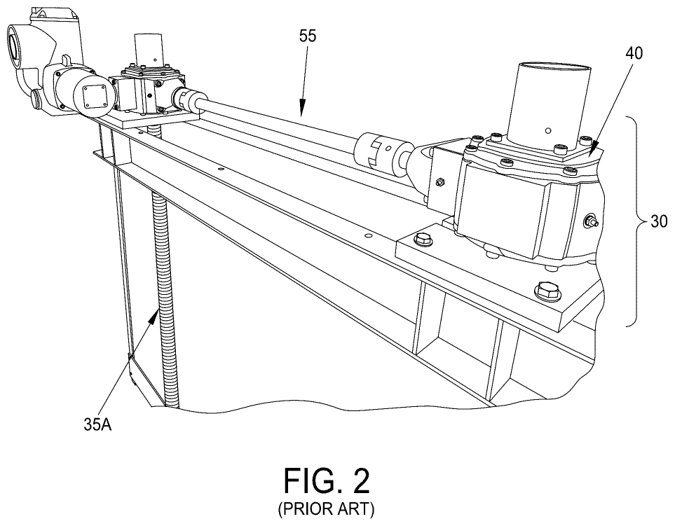

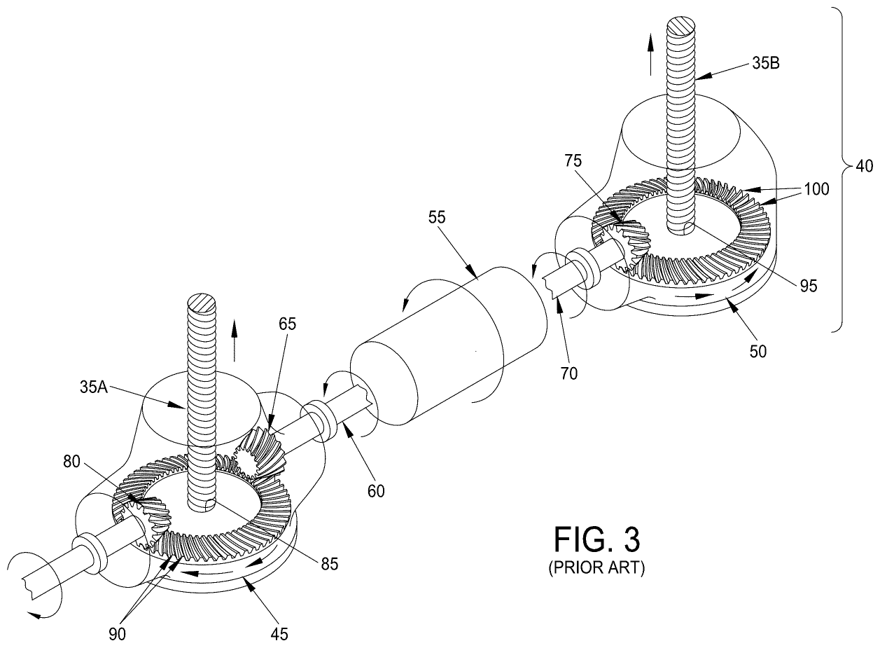

### DETAILED DESCRIPTION OF THE PREFERRED EMBODIMENTS

The present invention comprises the provision and use of a new and improved gearbox which operates to move at least two stems having threads of the same directionality disposed thereon, such that the stems move longitudinally in a common direction, eliminating the need to provide stems having oppositely-directed threads.

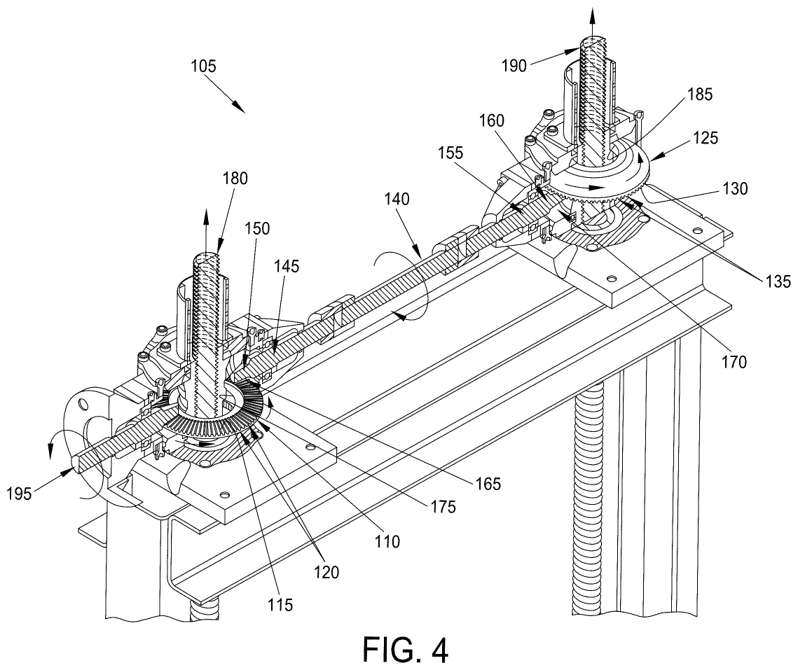

More particularly, and looking now at FIG. 4, there is shown a novel gearbox 105 formed in accordance with the present invention. Gearbox 105 generally comprises a first bevel gear 110 comprising an upper surface 115 having a plurality of teeth 120 formed thereon, a second bevel gear 125 comprising a lower surface 130 having a plurality of teeth 135 formed thereon, and a pinion shaft 140 connecting first bevel gear 110 and second bevel gear 125.

Pinion shaft 140 generally comprises a first end 145 having a first pinion gear 150 mounted thereto, and a second end 155 having a second pinion gear 160 mounted thereto. First pinion gear 150 comprises a plurality of teeth 165 configured to mate with teeth 120 of first bevel gear 110, such that rotation of first bevel gear 110 effects rotation of first pinion gear 150. Second pinion gear 160 comprises a plurality of teeth 170 configured to mate with teeth 135 of second bevel gear 125, such that rotation of second pinion gear 160 effects rotation of second bevel gear 125.

First bevel gear 110 comprises a threaded central opening 175 configured to mate with a first threaded stem 180 such that when first bevel gear 110 rotates relative to first threaded stem 180, first threaded stem 180 moves longitudinally relative to threaded central opening 175 of first bevel gear 110.

Second bevel gear 125 comprises a threaded central opening 185 configured to mate with a second threaded stem 190 such that when second bevel gear 125 rotates relative to second threaded stem 190, second threaded stem 190 moves longitudinally relative to threaded central opening 185 of second bevel gear 125.

Importantly, and as will be appreciated with reference to FIG. 4, teeth 120 of first bevel gear 110 are formed on upper surface 115 of first bevel gear 110, and teeth 135 of second bevel gear 125 are formed on lower surface 130 of second bevel gear 125. Thus it will be appreciated that first bevel gear 110 is disposed such that teeth 120 are facing in a direction opposite to the direction of teeth 135 of second bevel gear 125. As a result of this construction, when first bevel gear 110 is rotated in a first direction (e.g., counter-clockwise), first pinion gear 150, pinion shaft 140 and second pinion gear 160 rotate in a second, opposite direction (e.g., clockwise), and second bevel gear 125 rotates in the first direction (e.g., counter-clockwise). Thus, by disposing the teeth of second bevel gear 125 on the opposite surface of the surface on which the teeth of first bevel gear 110 are disposed, the achieved effect when using the two linking pinion gears discussed above is that both first bevel gear 110 and second bevel gear 125 rotate in the same direction.

It will be appreciated that the foregoing configuration may be reversed without departing from the scope of the present invention. That is, if desired, teeth 120 of first bevel gear 110 may be formed on a lower surface of first bevel gear 110 and teeth 135 of second bevel gear 125 may be formed on an upper surface of second bevel gear 125. An important feature of the present invention is that the relative dispositions of the teeth of the first bevel gear 110 relative to the teeth of the second bevel gear 125 are reversed, with the effect that rotation of first bevel gear 110 causes rotation of second bevel gear 125 in the same direction. Inasmuch as novel gearbox 105 is configured such that both first bevel gear 110 and second bevel gear 125 rotate in the same direction, it will be appreciated that first threaded stem 180 and second threaded stem 190 may comprise a thread having the same directionality and move longitudinally in concert, in the same direction, when first bevel gear 110 and second bevel gear 125 are rotated.

If desired, a third pinion gear 195 comprising a plurality of teeth configured to mate with teeth 120 of first bevel gear 110 may be provided in order to effect rotation of first bevel gear 110 via a source configured to rotate third pinion gear 195 (e.g., a crank or electric motor, etc.).

As a result of this construction, rotation of third pinion gear 195 (e.g., via a crank, not shown) in a count-clockwise direction causes (i) first bevel gear 110 to rotate in a counter-clockwise direction, (ii) first pinion gear 150, pinion shaft 140 and second pinion gear 160 to rotate in a clockwise direction, and (iii) second bevel gear 125 to rotate in a counter-clockwise direction. It will be appreciated that, as first bevel gear 110 and second bevel gear 125 are rotating (in the same counter-clockwise direction), threaded stems 180, 190 (with threads having the same directionality provided thereon) move in concert longitudinally within the central openings of first bevel gear 110 and second bevel gear 125, respectively, to move an object connected to stems 180, 190 (e.g., a slide gate), whereby to move the object (e.g., a slide gate) longitudinally.

### MODIFICATIONS OF THE PREFERRED EMBODIMENTS

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. Apparatus for effecting movement of an object, the apparatus comprising:
a first bevel gear having a first central opening formed therein, the first bevel gear comprising an upper surface and a lower surface;
a second bevel gear having a second central opening formed therein, the second bevel gear comprising an upper surface and a lower surface;
a first threaded stem passing through the first central opening of the first bevel gear, the first threaded stem comprising a thread configured to mate with a thread formed in the first central opening of the first bevel gear;
a second threaded stem passing through the second central opening of the second bevel gear, the second threaded stem comprising a thread configured to mate with a thread formed in the second central opening of the second bevel gear;
a pinion gear comprising a first end and a second end, wherein the first end of the pinion gear is configured to engage a plurality of teeth formed on the upper surface of the first bevel gear, and the second end of the pinion gear is configured to engage a plurality of teeth formed on the lower surface of the second bevel gear; and
wherein rotation of the first bevel gear in a first direction effects (i) longitudinal movement of the first threaded stem relative to the first bevel gear, and (ii) rotation of the second bevel gear in the first direction, and further wherein rotation of the second bevel gear in the first direction effects longitudinal movement of the second threaded stem relative to the second bevel gear.

2. The apparatus of claim 1 wherein the thread of the first threaded stem and the thread of the second threaded stem are threaded in the same direction.

3. The apparatus of claim 1 wherein the threads of the first threaded stem have a first pitch and the threads of the second threaded stem have a second pitch, and further wherein the first pitch and the second pitch are identical.

4. The apparatus of claim 1 wherein the first threaded stem and the second threaded stem are mounted to an object, and further wherein longitudinal movement of the first threaded stem and the second threaded stem effects longitudinal movement of the object.

5. The apparatus of claim 4 wherein the object is a slide gate.

6. The apparatus of claim 1 wherein the first end of the pinion gear comprises a first pinion gear comprising a plurality of teeth configured to engage with the plurality of teeth formed on the upper surface of the first bevel gear, and the second end of the pinion gear comprises a second pinion gear comprising a plurality of teeth configured to engage with the plurality of teeth formed on the lower surface of the second bevel gear.

7. The apparatus of claim 6 further comprising a pinion shaft extending between the first pinion gear and the second pinion gear.

8. The apparatus of claim 7 wherein rotation of the first bevel gear in the first direction effects rotation of the pinion shaft in a second direction, and further wherein the second direction is opposite to the first direction.

9. The apparatus of claim 1 further comprising an input pinion gear comprising a first end and a second end, wherein the first end of the input pinion gear is configured to engage a plurality of teeth formed on the upper surface of the first bevel gear, such that rotation of the input pinion gear effects rotation of the first bevel gear.

10. The apparatus of claim 9 further comprising a crank connected to the second end of the input pinion gear for rotating the input pinion gear.

11. The apparatus of claim 9 further comprising a motor mounted to the second end of the input pinion gear for rotating the input pinion gear.

12. A method for moving an object, the method comprising:
providing apparatus for effecting movement of the object, the apparatus comprising:
a first bevel gear having a first central opening formed therein, the first bevel gear comprising an upper surface and a lower surface;
a second bevel gear having a second central opening formed therein, the second bevel gear comprising an upper surface and a lower surface;
a first threaded stem passing through the first central opening of the first bevel gear, the first threaded stem comprising a thread configured to mate with a thread formed in the first central opening of the first bevel gear;
a second threaded stem passing through the second central opening of the second bevel gear, the second threaded stem comprising a thread configured to mate with a thread formed in the second central opening of the second bevel gear; and
a pinion gear comprising a first end and a second end, wherein the first end of the pinion gear is configured to engage a plurality of teeth formed on the upper surface of the first bevel gear, and the second end of the pinion gear is configured to engage a plurality of teeth formed on the lower surface of the second bevel gear; and
rotating the first bevel gear in a first direction, whereby to effect (i) longitudinal movement of the first threaded stem relative to the first bevel gear, and (ii) rotation of the second bevel gear in the first direction, wherein rotation of the second bevel gear in the first direction effects longitudinal movement of the second threaded stem relative to the second bevel gear, such that the first threaded stem and the second threaded stem move longitudinally in concert with one another.
